(19) United States
(12) Patent Application Publication
(10) Pub. No.: US 2015/0323928 A1
(43) Pub. Date: Nov. 12, 2015

(54) SYSTEM AND METHOD FOR DIAGNOSING FAILURE OF SMART SENSOR OR SMART ACTUATOR OF VEHICLE

(71) Applicant: HYUNDAI MOTOR COMPANY, Seoul (KR)

(72) Inventors: Sangjin Yim, Seoul (KR); Chang Yu Kim, Bucheon-si (KR); Jea Myoung Youn, Suwoni-si (KR)

(21) Appl. No.: 14/521,188

(22) Filed: Oct. 22, 2014

(30) Foreign Application Priority Data
May 8, 2014 (KR) 10-2014-0055058

(51) Int. Cl. G05B 23/00

(52) U.S. Cl. CPC G05B 23/00

(57) ABSTRACT

A system and method for diagnosing a failure of a smart sensor or a smart actuator of a vehicle are provided to diagnose the failure of the smart sensor or the smart actuator based on a detection result of a plurality of controllers connected as a network performing a plurality of logic detections. The method includes collecting, by a main controller, failure information detected by each of the controllers of the vehicle and determining a failure by integrating the failure information of each controller. In addition, the main controller is configured to request a failure confirmation from each controller when the failure occurs and diagnosing a failure of the smart sensor or the smart actuator when the failure confirmation is received.

### CROSS-REFERENCE TO RELATED APPLICATION

This application claims priority to and the benefit of Korean Patent Application No. 10-2014-0055058 filed in the Korean Intellectual Property Office on May 8, 2014, the entire contents of which are incorporated herein by reference.

### BACKGROUND

(a) Field of the Invention

The present invention relates to a system and method for diagnosing a failure of a smart sensor or a smart actuator of a vehicle. More particularly, the present invention relates to a method for diagnosing a failure of a smart sensor or a smart actuator of a vehicle that diagnoses the failure of the smart sensor or the smart actuator based on a detection result of a plurality of controllers connected as a network performing a plurality of logic detections.

(b) Description of the Related Art

Generally, a vehicle includes an engine configured to generate power, a power transmitting device configured to convert the power generated by the engine to torque of a wheel, a steering device configured to change a driving direction, a brake device configured to stop the vehicle, and an air conditioner configured to adjust temperature within a vehicle to provide an appropriate interior environment. A contemporary vehicle operates the componentry according to controllers for improving drivability, stability, ride comfort, and convenience of the vehicle.

The controllers diagnose states of each component and operate each component using a sensor or an actuator of the vehicle. Recently, the controllers have used a smart sensor or a smart actuator for supplementing a communication function to share information of the sensor or the actuator. The smart sensor or the smart actuator may be accessible to the different controllers; however it may only be operated by a corresponding controller. Thus, the corresponding controller independently diagnoses a failure of the smart sensor or the smart actuator. When a corresponding controller independently diagnoses a failure of the smart sensor or the smart actuator, a malfunction of the smart sensor or the smart actuator may occur due to an incorrect diagnosis. In addition, a problem of the entire control system of the vehicle may occur.

The above information disclosed in this section is merely for enhancement of understanding of the background of the invention and therefore it may contain information that does not form the prior art that is already known in this country to a person of ordinary skill in the art.

### SUMMARY

The present invention provides a system and method for diagnosing a failure of a smart sensor or a smart actuator of a vehicle, having advantages of diagnosing the failure based on a detection result by a plurality of controllers connected as a network performing a plurality of logic detections.

An exemplary embodiment of the present invention provides a method for diagnosing a failure of a smart sensor or a smart actuator of a vehicle that may include collecting failure information detected by each controller of the vehicle, determining a failure by integrating the failure information of each controller, requesting a failure confirmation from each controller when the failure occurs, and finally diagnosing a failure of the smart sensor or the smart actuator when the failure is confirmed.

Each controller of the vehicle may further include a failure detecting logic configured to detect a failure of the smart sensor or the smart actuator. The determination of a failure by integrating the failure information of each controller may determine that the failure occurs when all of controllers (e.g., the different controllers) detect the failure. In addition, the determination of a failure by integrating the failure information of each controller may determine that the failure occurs when a predetermined number of controllers detect the failure. The determination of a failure by integrating the failure information of each controller may also determine that the failure occurs when a failure criterion value calculated by each controller by applying a weight value is greater than a predetermined value. Further, the determination of a failure by integrating the failure information of each controller may determine that the failure occurs when one or more controller detects the failure.

The method may further include requesting a failure recovery of the smart sensor or the smart actuator after diagnosing the final failure of the smart sensor or the smart actuator.

According to an exemplary embodiment of the present invention as described above, the method diagnoses the failure of the smart sensor or the smart actuator based on a detection result by a plurality of controllers connected as a network, so a probability of misdiagnosis may be decreased and unavailability of diagnosis according to failure of a single controller may be prevented.

### BRIEF DESCRIPTION OF THE DRAWINGS

These and/or other aspects of the invention will become apparent and more readily appreciated from the following description of the exemplary embodiments, taken in conjunction with the accompanying drawings of which:

FIG. 1 is an exemplary schematic diagram of a control system including a plurality of controllers to which a method for diagnosing a failure of a smart sensor or a smart actuator of a vehicle is applied according to an exemplary embodiment of the present invention;

FIG. 2 is an exemplary schematic diagram of a hybrid control system to which a method for diagnosing a failure of a smart sensor or a smart actuator of a vehicle is applied according to an exemplary embodiment of the present invention; and

FIG. 3 is an exemplary flowchart showing a method for diagnosing a failure of a smart sensor or a smart actuator of a vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, exemplary embodiments of the present invention have been shown and described, simply by way of illustration. As those skilled in the art would realize, the described exemplary embodiments may be modified in various different ways, all without departing from the spirit or scope of the present invention. Like reference numerals designate like elements throughout the specification.

An exemplary embodiment of the present invention will hereinafter be described in detail with reference to the accompanying drawings.

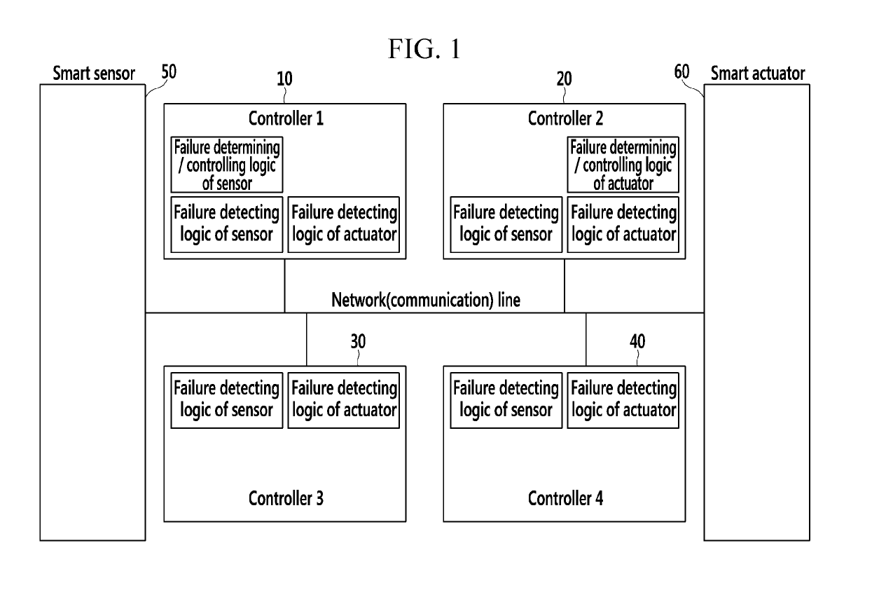

FIG. 1 is an exemplary schematic diagram of a control system including a plurality of controllers to which a method for diagnosing a failure of a smart sensor or a smart actuator of a vehicle is applied according to an exemplary embodiment of the present invention. As shown in FIG. 1, a control system to which a method for diagnosing a failure of a smart sensor or a smart actuator of a vehicle is applied according to an exemplary embodiment of the present invention may include a plurality of controllers including a first controller 10, a second controller 20, a third controller 30, and a fourth controller 40, a plurality of smart sensors 50 operated by the plurality of controllers, and a plurality of smart actuators 60 operated by the plurality of controllers.

The first controller 10, second controller 20, third controller 30, and fourth controller 40 may include a failure detecting logic of the smart sensor or the smart actuator configured to detect a failure of a corresponding smart sensor or a corresponding smart actuator. The controllers may be mounted on an engine management system (EMS), a hybrid control unit (HCU), a transmission control unit (TCU), a battery management system (BMS), electronic command steering (ECS), motor driven power steering (MDPS), a lane keeping assist system (LKAS), smart cruise control (SCC), etc., and may be connected to each other through controller area network (CAN) communication. Each controller may initiate communication when power of the vehicle is turned on, and may be configured to output a signal to the first controller 10 configured to detect a failure of the smart sensor or the second controller 20 configured to detect a failure of the smart actuator via the CAN communication.

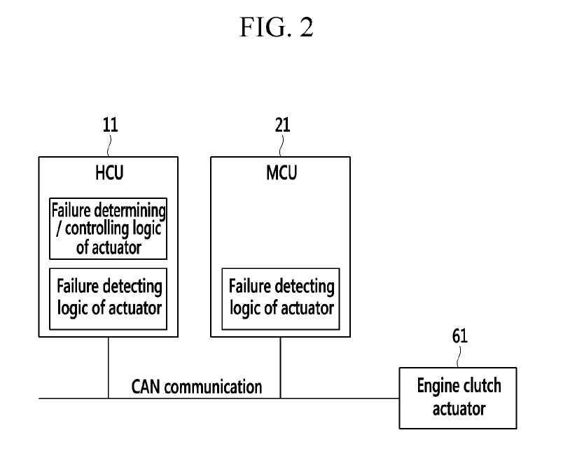

FIG. 2 is an exemplary schematic diagram of a hybrid control system to which a method for diagnosing a failure of a smart sensor or a smart actuator of a vehicle is applied according to an exemplary embodiment of the present invention. For example, a hybrid control system to which a method for diagnosing a failure of a smart sensor or a smart actuator of a vehicle is applied according to an exemplary embodiment of the present invention may include an HCU 11, an MCU 21, and an engine clutch actuator 61.

The HCU 11 and the MCU 21 may be connected via the CAN communication and may include each failure detecting logic of the actuator to detect a failure of a corresponding actuator. The HCU 11, which may be a superordinate controller, may further include a failure determining logic to determine a failure of the actuator according to a failure detection signal of the actuator output from each controller. In other words, the HCU 11 may be configured to receive the failure detection signals of the engine clutch actuator 61 detected by the HCU 11 and the MCU 21 via each failure detecting logic, and may be configured to diagnose the failure of the engine clutch actuator 61 by integrating the failure detection signals of the engine clutch actuator 61.

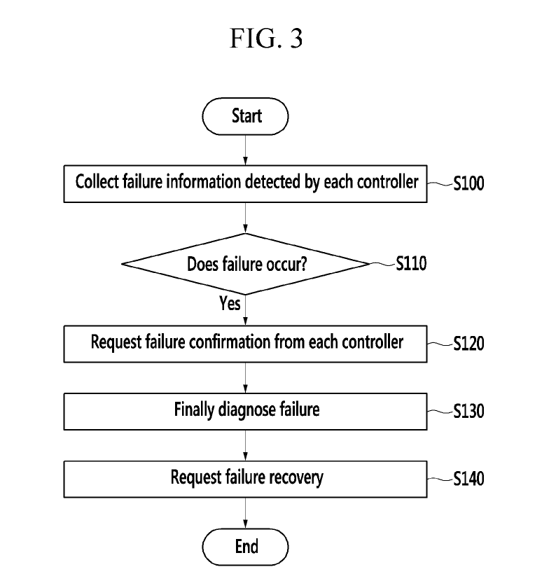

FIG. 3 is an exemplary flowchart showing a method for diagnosing a failure of a smart sensor or a smart actuator of a vehicle according to an exemplary embodiment of the present invention. As shown in FIG. 3, the method for diagnosing the failure of the smart sensor or the smart actuator of the vehicle according to an exemplary embodiment of the present invention may begin with collecting failure information detected by each controller of the vehicle at step S100. As described above, each controller may include a failure detecting logic of the smart sensor or the smart actuator to detect a failure of a corresponding smart sensor or corresponding smart actuator.

Each controller may be configured to detect a failure using the failure detecting logic of the smart sensor or the smart actuator, and output a failure detection signal to a main controller having control rights (e.g., operation control) of the smart sensor or the smart actuator. When the failure information is detected by each controller at the step S100, the main controller may be configured to determine a failure by integrating the failure information of each controller at step S110.

The main controller may also be configured to determine that the failure occurs when all controllers detect the failure, a predetermined number of controllers detect the failure, a failure criterion value calculated by each controller by applying a weight value is greater than a predetermined value, or one or more controllers detect the failure at the step S110. When the failure occurs at the step S110, the main controller may be configured to request a failure confirmation from corresponding controller at step S120.

The main controller may further be configured to diagnose that the failure occurs based on a requested failure confirmation at step S130. The main controller may be configured to select a failure detection method from methods used in the step S110 and diagnose a final failure. When the main controller diagnoses a failure occurrence at the step S130, the main controller may be configured to request a failure recovery of the smart sensor or the smart actuator at step S140. In the step S140, the main controller may be configured to store information regarding the failure occurrence to a buffer (e.g., a memory) to output a signal of the failure recovery.

According to an exemplary embodiment of the present invention as described above, the method diagnoses the failure of the smart sensor or the smart actuator based on a detection result by a plurality of controllers connected as a network, and accordingly, a probability of misdiagnosis may be decreased and unavailability of diagnosis according to a failure of single controller may be prevented.

While this invention has been described in connection with what is presently considered to be exemplary embodiments, it is to be understood that the invention is not limited to the disclosed exemplary embodiments. On the contrary, it is intended to cover various modifications and equivalent arrangements included within the spirit and scope of the appended claims.

What is claimed is:

1. A method for diagnosing a failure of a smart sensor or a smart actuator of a vehicle, the method comprising:
collecting, by a main controller, failure information detected by each of a plurality of controllers of the vehicle;
determining, by the main controller, a failure by integrating the failure information of each controller;
requesting, by the main controller, a failure confirmation from each controller when the failure occurs; and
diagnosing, by the main controller, a failure of the smart sensor or the smart actuator in response to receiving the failure confirmation.

2. The method of claim 1, wherein each controller of the vehicle includes a failure detecting logic for detecting a failure of the smart sensor or the smart actuator.

3. The method of claim 1, wherein the determination of a failure by integrating the failure information of each controller determines that the failure occurs when all of the controllers detect the failure.

4. The method of claim 1, wherein the determination of a failure by integrating the failure information of each controller determines that the failure occurs when a predetermined number of the controllers detect the failure.

5. The method of claim 1, wherein the determination of a failure by integrating the failure information of each controller determines that the failure occurs when a failure criterion value calculated by each controller by applying a weight value is greater than a predetermined value.

6. The method of claim 1, wherein the determination of a failure by integrating the failure information of each controller determines that the failure occurs when one or more of the controllers detect the failure.

7. The method of claim 1, further comprising:
requesting, by the main controller, a failure recovery of the smart sensor or the smart actuator after diagnosing the final failure of the smart sensor or the smart actuator.

8. A system for diagnosing a failure of a smart sensor or a smart actuator of a vehicle, the system comprising:
a memory configured to store program instructions; and
a processor configured to execute the program instructions, the program instructions when executed configured to:
collect failure information detected by each of a plurality of controllers of the vehicle;
determine a failure by integrating the failure information of each controller;
request a failure confirmation from each controller when the failure occurs; and
diagnose a failure of the smart sensor or the smart actuator in response to receiving the failure confirmation.

9. The system of claim 8, wherein each controller of the vehicle includes a failure detecting logic for detecting a failure of the smart sensor or the smart actuator.

10. The system of claim 8, wherein the determination of a failure by integrating the failure information of each controller determines that the failure occurs when all of the controllers detect the failure.

11. The system of claim 8, wherein the determination of a failure by integrating the failure information of each controller determines that the failure occurs when a predetermined number of the controllers detect the failure.

12. The system of claim 8, wherein the determination of a failure by integrating the failure information of each controller determines that the failure occurs when a failure criterion value calculated by each controller by applying a weight value is greater than a predetermined value.

13. The system of claim 8, wherein the determination of a failure by integrating the failure information of each controller determines that the failure occurs when one or more of the controllers detect the failure.

14. The system of claim 8, wherein the program instructions when executed are further configured to:
request a failure recovery of the smart sensor or the smart actuator after diagnosing the final failure of the smart sensor or the smart actuator.

15. A non-transitory computer readable medium containing program instructions executed by a controller, the computer readable medium comprising:
program instructions that collect failure information detected by each of a plurality of controllers of the vehicle;
program instructions that determine a failure by integrating the failure information of each controller;
program instructions that request a failure confirmation from each controller when the failure occurs; and
program instructions that diagnose a failure of the smart sensor or the smart actuator in response to receiving the failure confirmation.

16. The non-transitory computer readable medium of claim 15, wherein each controller of the vehicle includes a failure detecting logic for detecting a failure of the smart sensor or the smart actuator.

17. The non-transitory computer readable medium of claim 15, further comprising:
program instructions that request a failure recovery of the smart sensor or the smart actuator after diagnosing the final failure of the smart sensor or the smart actuator.

18. The non-transitory computer readable medium of claim 15, wherein the determination of a failure by integrating the failure information of each controller determines that the failure occurs when a failure criterion value calculated by each controller by applying a weight value is greater than a predetermined value.

19. The non-transitory computer readable medium of claim 15, wherein the determination of a failure by integrating the failure information of each controller determines that the failure occurs when one or more of the controllers detect the failure.

20. The non-transitory computer readable medium of claim 15, wherein the determination of a failure by integrating the failure information of each controller determines that the failure occurs when a predetermined number of the controllers detect the failure.
